(19) United States
(12) Patent Application Publication
(10) Pub. No.: US 2017/0127480 A1
(43) Pub. Date: May 4, 2017

(54) HEATING SYSTEM

(71) Applicant: Inductive Engineering Technology, LLC, Cocoa Beach, FL (US)

(72) Inventors: Stamatios Hadoulias, Rockledge, FL (US); Darryl L. Snyder, North Canton, OH (US); John C. May, Cocoa Beach, FL (US)

(21) Appl. No.: 15/401,993

(22) Filed: Jan. 9, 2017

Related U.S. Application Data
(63) Continuation-in-part of application No. 15/051,604, filed on Feb. 23, 2016, now Pat. No. 9,544,945.
(60) Provisional application No. 62/121,489, filed on Feb. 26, 2015.

(51) Int. Cl. H05B 6/10; F24D 3/10

(52) U.S. Cl. CPC H05B 6/10; F24D 3/1066; H05B 2206/024

(57) ABSTRACT

A magnetic induction thermal heat unit, capable of producing heat by magnetic field, inducing direct agitation and friction, at the molecular level within a ferrous magnetic or semi-magnetic thermal conductor. The thermal conductors can be joined or bonded to non-magnetic or ferrous materials as a conductive heat path to a thermal transfer device.

### INCORPORATION BY REFERENCE TO ANY PRIORITY APPLICATIONS

This application is a continuation-in-part of Ser. No. 15/051604, filed Feb. 23, 2016, which claims priority to U.S. Application No. 62/121,489, filed Feb. 26, 2015, each of which is incorporated by reference in its entirety into this application.

### BACKGROUND

Field

Heat sources can use radiant, resistive, infrared, quartz and other sources of energy similar in nature using electrical current produced or procured from standard residential or commercial electrical power distribution sources, or from fossil-fueled heat sources or burners. An exemplary conventional system supplies current through a resistive material to heat the material. Air or other convective medium is then used to transfer the heat from the resistive material to a remote location of interest. Such systems are extremely inefficient as there is substantial loss in heating the resistive material and transporting the heat convectively to the remote location.

Description of the Related Art

Induction heating uses a magnetically conductive material, such as a ferrous metal, metal compound, or metal alloy, by inducting circulating currents within the material (the receptor) using an alternating magnetic field. An exemplary conventional induction heating system is for cook oven surfaces that directly heat the cookware within the magnetic field produced by an alternating current supplied to a ferrous metal pan positioned on the cook surface. These however require special cookware. Typically, magnetic induction devices are single purpose systems built specifically for an identified application where a single heating parameter is specified. Also, since the heated material must be within the magnetic field created by an alternating magnetic field to generate heat, these systems require substantial space at the location of generating heat. These systems therefore are typically limited to larger heating systems where heat is provided in a limited and immediate space.

### SUMMARY

Exemplary heating systems described herein include heat engines powered by magnetic induction and thermal transfer mediums for use as thermal energy distribution systems. In general, the exemplary heat engine produces a high efficiency source of thermal energy that may be used to supplement or replace conventional heaters.

### BRIEF DESCRIPTION OF THE DRAWINGS

FIG. 1 is a diagram illustrating an embodiment of a heating system.

FIG. 2 is a diagram illustrating an embodiment of a controller.

FIG. 3A is a diagram illustrating an embodiment of a furnace that includes a heating system, and FIG. 3B is a close up view of a portion of the heating system shown in FIG. 3A.

FIG. 4A is a diagram illustrating an embodiment of a space heater that includes a heating system, FIG. 4B is a close up view of a portion of the heating system shown in FIG. 4A, and FIG. 4C is a cut away view of a portion of the heating system shown in FIG. 4B.

FIG. 5 is a diagram illustrating an exploded view of an embodiment of the heat engine shown in FIGS. 4A-4C.

FIGS. 6A, 6B, and 6C are diagrams illustrating embodiments of various heating apparatus that include a heating system.

FIGS. 7A and 7B are diagrams illustrating embodiments of a water heater that includes a heating system.

FIG. 8 is a diagram illustrating an embodiment of an air dryer that includes a heating system.

FIGS. 9A and 9B are diagrams illustrating embodiments of heat exchangers that can form part of the heating system.

### DETAILED DESCRIPTION

Embodiments described herein include systems and methods in which a heating system can be used to provide a reliable, cost efficient method of heating for a multitude of uses. In some embodiments, the system includes a magnetic field generator and a thermal conductor that is made of one or more ferrous magnetic and/or semi-magnetic substrates. The magnetic field generator can generate a magnetic field, which can induce direct agitation and friction, at the molecular level within the ferrous magnetic and/or semi-magnetic material. The thermal conductor can store and/or transfer the generated heat to a subsequent device that uses heat.

The system can use the thermal conductor in various configurations. In some cases, the thermal conductor can include one or more ferrous substrates and/or one or more non-ferrous substrates, such as aluminum or copper. The ferrous and non-ferrous substrates of the thermal conductor can have relatively high thermal conductivity properties and can form a conductive heat path to a thermal transfer device, such as a heat pipe. In some embodiments, the convective and resultant radiant heat from the system can be used as part of the total heat energy produced. In certain cases, the system can increase the amount of heat produced per watt of electricity.

Although embodiments may be described and illustrated herein in terms of specific applications, it should be understood that the concepts described herein are not so limited and can be used in any number of applications in which a heat source is used. Furthermore, although certain embodiments are described and illustrated herein in terms of specific configurations and materials, it should be understood that the concepts also include other alternatives as would be apparent to a person of skill in the art. Exemplary embodiments of specific configurations are provided herein. Features, arrangements, components, and functions may be interchanged between embodiments, such that any component, arrangement, or function may be integrated, subdivided, duplicated, added, removed, or otherwise combined or rearranged with any other embodiment described herein.

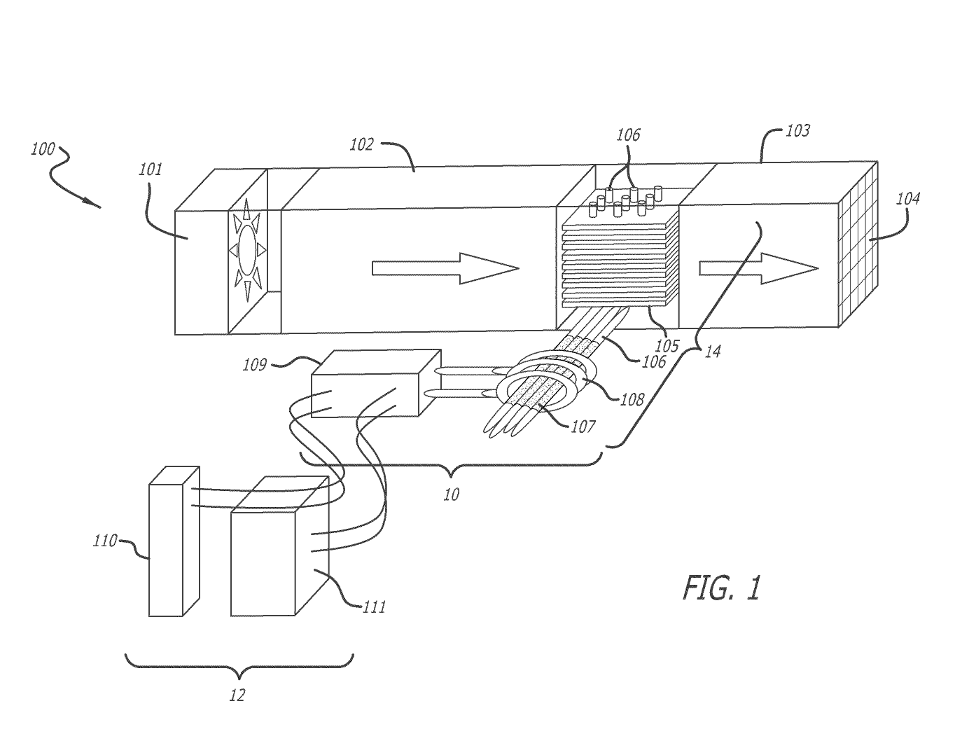

FIG. 1 is a diagram illustrating an embodiment of a heating system. In the illustrated embodiment, the heating system includes a heat engine 10, controller 12, and thermal transfer device 14, which can also be referred to as a heat transfer device. The controller 12 controls the heat engine 10 to produce heat in a desired temperature range and the thermal transfer device 14 transfers the generated heat from the heat engine 10 to a target destination.

The heat engine 10 can be used to replace an existing heat generating device in a variety of products, and can be used by itself or in conjunction with one or more other system components as described herein. The heat engine 10 can be portable or fixed. In some embodiments, the heat engine 10 includes an induction generator 109, induction coils 108, and one or more thermal conductors 107.

The induction generator 109 produces an alternating or changing current through induction coils 108 that creates an alternating or changing magnetic field. An exemplary embodiment of the heat engine 10 includes an electromagnet through which a high-frequency alternating current (AC) is passed. Positioned within the generated, alternating magnetic field is the thermal conductor(s) 107. The thermal conductor(s) 107 can be made of one or more substrates and can include at least one substrate made of a magnetic or ferrous metal that can be agitated at the molecular level by the generated magnetic field.

In certain cases, the heat engine 10 uses magnetic induction where capacitive and inductive reactance create resonant frequencies of magnetic fields and/or eddy currents, electrical currents, magnetic flux densities, and combinations thereof to directly agitate the molecular structure of magnetic or ferrous metals to the point where immediate heating from accelerated atomic particle friction occurs to the metal substrate directly within the magnetic field.

The heat engine 10 is configured to create a magnetic field sufficient to accelerate at the molecular level, particles in the thermal conductor 107 to the point of producing efficient heat. The efficiency of the heating occurs at the magnetically induced substrate level eliminating or reducing the losses typically encountered through conventional heating devices employing multiple substrate surfaces and conduction through various material compositions.

In certain embodiments, the heat engine 10 can be located remote from ducting, a heat exchanger, a thermal transfer device, or final target for the generated heat. In some cases, the heat energy from the heat engine 10 can be channeled to a remote location with negligible or reduced thermal losses along at least a length to the remote destination. The heat engine 10 (which can also be referred to as a heat source) can be separated from the destination target allowing flexibility to incorporate multiple design configurations for new product development, or retrofitting into existing products. For example, in some embodiments, the heat from the heat engine 10 or heat source can be transported by a thermal transfer device, such as a heat pipe. The thermal transfer device can use convection, conduction, fluid transfer mechanisms via thermally conductive or eutectic solutions, hot plates, finned coils, heat sinks, or other known heat transfer mechanisms, and combinations thereof.

As mentioned, in certain embodiments, the thermal transfer device includes a heat pipe that combines principles of both thermal conductivity and phase transition to efficiently manage the transfer of heat between two interfaces. At the hot interface of a heat pipe, a heatable solution, such as a liquid (non-limiting examples: ammonia, helium, deionized water, etc.), in contact with a thermally conductive solid surface turns into a vapor by absorbing heat from the hot conductive surface. The vapor can travel along the heat pipe to the cold interface and condense back into a liquid-releasing the latent heat. The liquid can returns to the hot interface through capillary action, centrifugal force, gravity, and combinations thereof to repeat the cycle. In some embodiments, the heat pipe can use heatable solutions other than a liquid. For example, the heatable solution can include potassium, sodium, lithium, silver, etc. Due to the very high heat transfer coefficients for boiling and condensation, heat pipes are highly efficient thermal conductors. In some cases, the heat pipe can include an outer layer of insulation to reduce heat loss as the solution travels along the heat pipe.

As further shown in FIG. 1, the thermal transfer device 14 can include heat pipes 106 and heat exchanger 105. The heat pipes 106 can be used to transfer the heat from the heat engine 10 to a target location and/or to another thermal transfer device, such as the convention HVAC ducting (including fan 101 and duct 102 and duct 103). The heat pipes 106 can be coupled to the thermal conductor(s) 107 to receive heat from the heat engine 10. The heat can be transported through the heat pipes 106 to a target location and/or to another other thermal transfer device, such as heat exchanger 105. The heat exchanger 105, for example, can transfer the heat generated by the heat engine 10 to an airflow, such as moved by fan 101 along duct 102. As the air passes the heat exchanger 105, the air is heated and transported to another destination by duct 103 and vent 104.

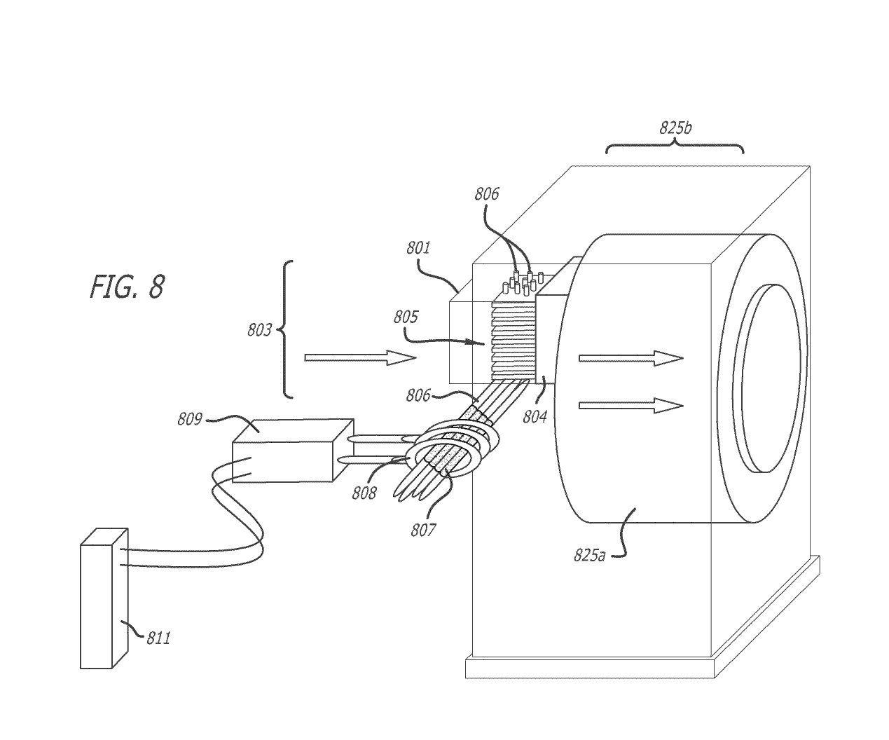

Heat Exchangers as described can be of a variety of configurations specific to the application thermal requirements. These can include finned type, heat sinks of thermally conductive material, extruded aluminum or other metal, ferrous or non-ferrous of high thermal conductivity configured to maximize the transfer of heat energy to the desired receptor. Some examples include, but are not limited to, those illustrated in FIGS. 8A and 8B.

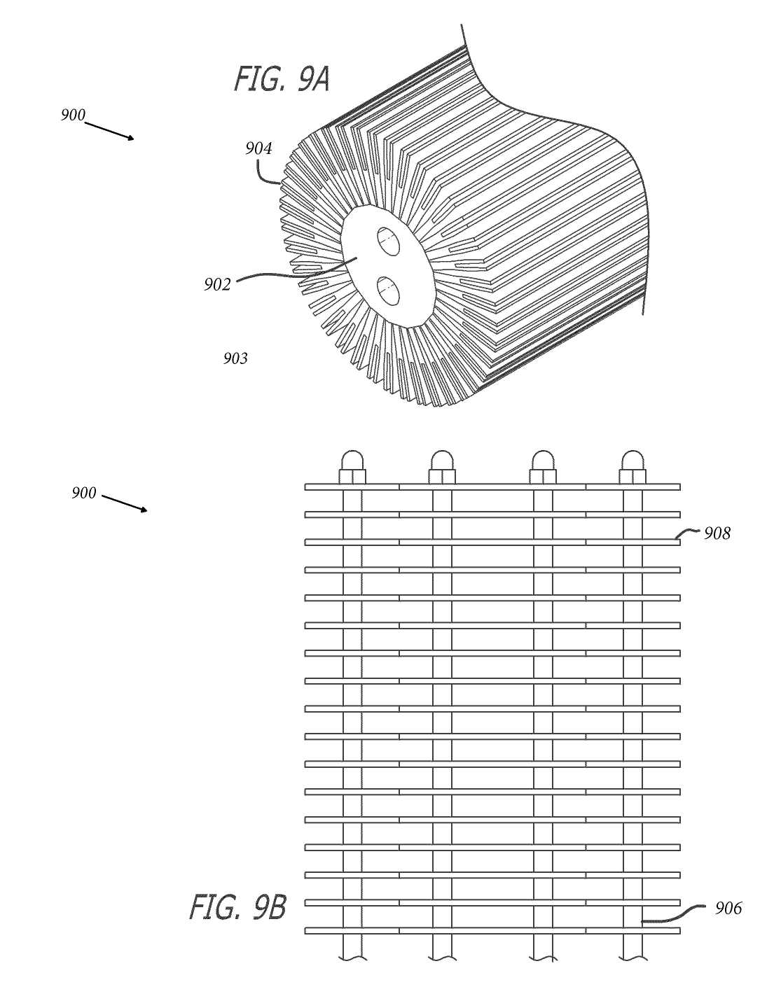

FIG. 9A is a diagram illustrating an embodiment of a heat exchanger 900. In the illustrated embodiment, the heat exchanger 900 includes a central core 902 and a peripheral edge of fins 904 or projections extending radially outward from the core 902. The core 902 and fins 904 can be made of a material having high thermal conductivity, such as metal, etc. In some cases, the core 902 and fins 904 can be coupled using solder or other material. The coupling agent can also be made of a material having high thermal conductivity, such as metal.

The core 902 can include one or more passages 903, for which a portion of the thermal transfer device can enter. In some embodiments, the passages 903 can extend through an entire length of the core 902 or only a portion thereof. In some cases, the passages 903 can be located proximate the center of the core 902 or the passages can be located on the periphery of the core 902, proximate the fins 904. In certain embodiments, the core 902 can include only one passage 903 or a plurality of passages. In some cases, the number of passages 903 can depend on the number of thermal transfer devices that are to be coupled to the core 902.

The circumference of the passages 903 can be sized such that the core 902 is in contact with the portion of the heat transfer system placed within the passages 903. In some cases, the perimeter of the passages 903 are sized such that the portions of the thermal transfer device that are located within the passages 903 are in direct contact with the core 902 along the length of the passage 903. Alternatively, the thermal transfer device can be in indirect contact with the core 902 via a thermally conductive material. Accordingly, in certain embodiments, the size of the perimeter of the passages 903 can vary depending on the size of the thermal transfer devices to be coupled thereto. In some cases, the core 902 can be molded to the thermal transfer device. The portion of the thermal transfer device coupled to the core 902 can transfer thermal energy to the heat sink core 902, which can transfer the heat outward to the fins 904 which can be cooled by a passing fluid such as air or liquid.

FIG. 9B is a diagram illustrating another embodiment of a heat exchanger 900. In the illustrated embodiment of FIG. 9B, the portions of the thermal transfer device 906 are directly exposed in the heat exchanger 900 to the transfer fluid and the heat exchanger 900 includes a plurality of planar heat exchange surfaces 908. As shown, the planar heat exchange surfaces 908 are generally planar and parallel to each other. In some embodiments, the portions of the thermal transfer device 906 can traverse through a plurality of planar heat exchange surfaces 908. As shown, the portions of the thermal transfer device 906 can extend generally perpendicular to the heat exchanger surfaces 908. However, it will be understood that the portions of the thermal transfer device 906 can extend at any angle to the heat exchanger surfaces 908 to facilitate fluid flow and heat transfer of and to the heat exchange medium. The planar heat exchange surface 908 can include passages for the heat pipes 906, and can include passages, apertures, projections, or other features for permitting, limiting, and/or directing fluid flow through the heat exchanger. Furthermore, the heat exchange surfaces 908 can be made of high thermal conductive material, such as metal.

Returning to FIG. 1, in some embodiments, the system includes a controller 12 for the heat engine 10 so that the magnetic energy can be focused or dynamically adjusted to reach a desired or maximum heat potential in various alloys, substrate configurations, thermal sinks and/or other combined magnetic induction and thermal conduction methods as necessary to produce the required heat capacity requirements for a particular application. For example, an exemplary embodiment of the heat engine can be dynamically adjusted so that the magnetic energy can be tuned or adjusted to correspond to one of a plurality of interchangeable substrates or dynamically adjusted to produce a desired or controlled heat output from a single substrate.

In certain embodiments, the controller 12 controls a magnetic induction circuit to produce a magnetic field specifically tailored for the configuration of the substrate surface directly affected and induced by the surrounding induction coil. The coil orientation and configuration can be altered to produce different patterns of magnetic fields, polarity, or configured to meet the physical dimensions of the substrate configuration within its field. In some embodiments, the system can be used with a single frequency, single voltage, for a predefined substrate, with an on/off cycle controlled by a temperature transducer to read “over shoot” and “under shoot” temperature ranges. For example, the system can be configured to operate at different voltages, such as, but not limited, 120V, 240V, 480V, etc. The system can be used in an A/C environment and/or DC environment using rectifiers and inverters, etc. In certain embodiments, the system can include adequate safety features, while retaining the ability to specifically tailor and program preset parameter ranges. In some embodiments, the heat engine 10 can be controlled in real time or semi real time with electronic logic devices to meet varying applications with a single or multiple circuit board design. In certain cases, the system can generate a specific and stable temperature range, along with the ability to accommodate varying levels of magnetic materials. In some cases, the controller 12 can also be used to control magnetic field penetration depths within multiple substrate configurations and temperatures. In some embodiments, a temperature sensor located proximal to the coil can measure the temperature and the controller can use the temperature to control the magnetic field. For example, if the temperature satisfies a high temperature threshold, the controller can reduce the amount of current flowing through the coil. Similarly, if the temperature satisfies a low temperature threshold, the controller can increase the amount of current flowing through the coil.

In an exemplary embodiment a magnetic induction circuit board can be used to provide radio frequency (RF) energy so that the frequency of the RF energy emitted as the magnetic field into the substrate can be frequency modulated. The magnetic field into the substrate can therefore be selected to correspond to specific requirements, such as to correspond to the density and magnetic attraction of the specific substrate. The magnetic field can therefore be focused to the particular substrate or operating parameter.

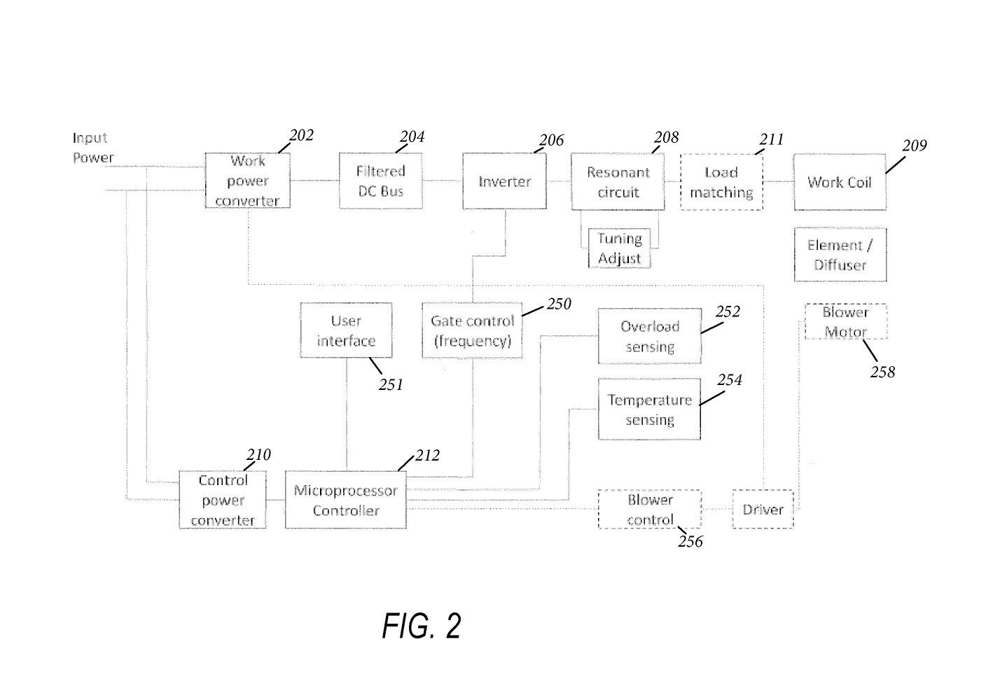

FIG. 2 is a diagram illustrating an embodiment of a controller that can be used as part of a heating system. The controller 12 can include solid state components, such as, but not limited to, switches, digital readouts, thermocouples or other measurement and logic devices. In the illustrated embodiment, the controller 12 includes a coil power converter 202, DC bus 204, inverter 206, resonant circuit and tuning adjust 208, control power converter 210 and microprocessor 212. The coil power converter 202, DC bus 204, inverter 206, resonant circuit and tuning adjust 208 can be used to control the coils 209 of the heat engine 12. In some embodiments, the components of the controller can be configured to provide load matching 211 for the coils 209

The microprocessor 212 can provide gate control 250 (and frequency control) to the inverter 206. The microprocessor can also provide a user interface 251 to enable a user to control the heating system. The microprocessor can further provide overload sensing 252 and temperature sensing 254 functionality. For example, the microprocessor can monitor the electrical power being used by the heat engine 10. If the power exceeds a safety threshold, the microprocessor can deactivate the heat engine 10. Similarly, the microprocessor can monitor the temperature at the substrates and/or target location. If the substrates become too hot or otherwise satisfy a temperature threshold, the microprocessor 212 can deactivate or reduce the power to the heat engine 10. Similarly, if the temperature at the target location reaches a desired temperature or otherwise satisfies a temperature threshold, microprocessor 212 can deactivate or reduce the power to the heat engine 10. In embodiments, that include a blower or fan, the microprocessor can provide blower control 256 to control a fan or other type of blower. In such embodiments, the controller 12 can include a driver for the blower motor 258.

The controller 12 can be used to control power generating circuits that provide the RF energy to the induction coil and heat transfer system. The controller 12 can take into consideration certain temperature ranges at the inlet and output stages, power application, and proportionate power settings to increase and/or maximize the efficiency of the system. For example, the controller 12 can monitor the heat engine 10, thermal transfer device, or any portion thereof (e.g., heat pipes), heat exchangers, target location, etc. The controller 12 can also include components for fans and fluid control devices within the entire unit and also to monitor safety and effective resource management of the complete assembly for its intended use. As an RF modulated device, frequency generation, measurement and control can also be included in the control panel circuitry. However, some embodiments, the system can remain at a fixed operational frequency fixed by dedicated resonant components. It will be understood that the controller 12 can include fewer or more components. For example, in some embodiments, the inverter 206 can be omitted.

In certain embodiments, coil cooling lines 111 and coil cooling pump unit 111 can also or alternatively be used for controlling induction coils 108 and induction generator 109 temperatures within specified limits. For example, a cooling line 111 can be coupled to the coil 108 and be used to keep the coil 108 from overheating. In some embodiments, one or more heat sinks can be coupled to the coils 108 to keep the coil 108 from overheating.

In some cases, the controller 12 can be used to track, store, and analyze the modulated frequency, voltage, current parameters, substrate material, substrate configuration, output temperature, and other system parameters to define and populate a database. The database can be used to define baseline information to permit a single component or group of system components to function in a multitude of ways for a multitude of applications.

Accordingly, certain embodiments can include a logic engine or computer system to evaluate and determine a proper magnetic induction parameter or set of parameters to control and/or anticipate system output requirements and system design outcomes based on one or more system inputs, system configurations, system components, and combinations thereof

Induction heaters can be used in numerous applications such as melting, forming, annealing, and welding metals in industrial applications. Other applications can include heating systems for use in heat, vacuum, and air conditioning (HVAC) systems. Non-limiting examples of conventional HVAC systems that can benefit from embodiments described herein include furnace, space heaters, and supplemental heaters for localized or targeted heat distribution within a larger heating system.

In certain embodiments, the heating system can be used as, or in, a furnace in a conventional HVAC arrangement for a dwelling. The heat engine can be used as a heat source, with the one or more heat pipes used as the thermal transfer device to a heat exchanger/heat transport of a conventional HVAC arrangement. For example, the controller 12 can be coupled to or integrated into the thermostat within a room, the heat engine 10 can replace the conventional furnace, and the thermal transfer device 14 can move heat from the heat engine 10 to the HVAC duct 102 and duct 103 of the dwelling.

In certain embodiments, the heating system can be used as part of a furnace where large quantities of air can be heated and distributed within a room for localized personal comfort or auxiliary heating in conjunction with HVAC systems already in place or as a standalone unit. For example, the heating system can used as part of or retrofitted into an existing HVAC air handling equipment replacing other heat sources, such as the heat strips, etc.. As yet another non-limiting example, the heating system can be used to directly heat the coils of a conventional “A” coil in an evaporative type Freon expansion and compressor type HVAC system. The coils may also or alternatively be heated by the heat transfer device 14.

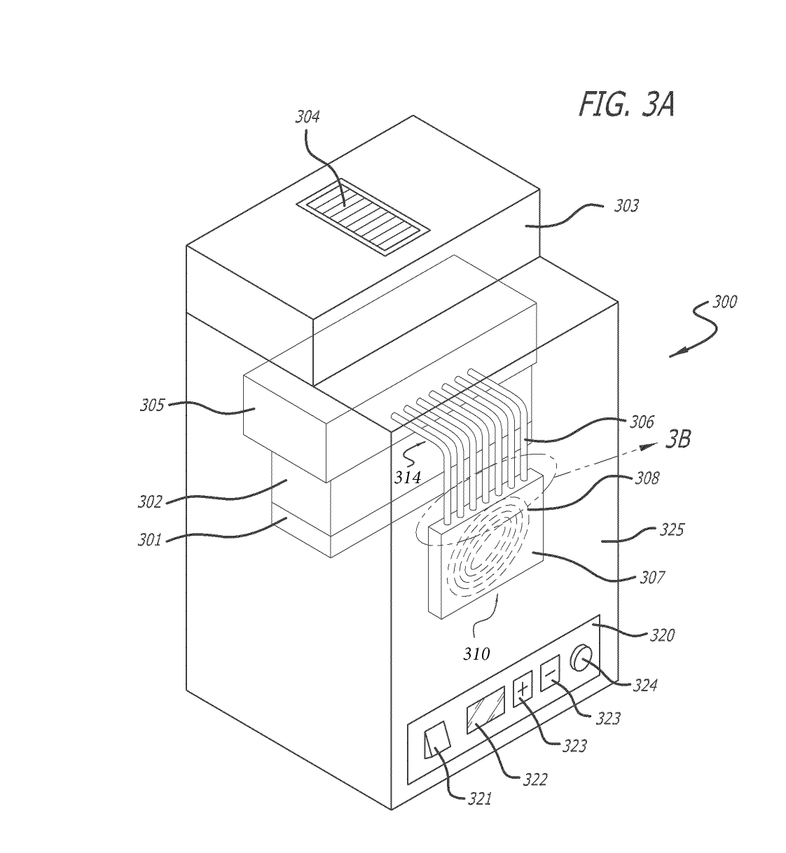

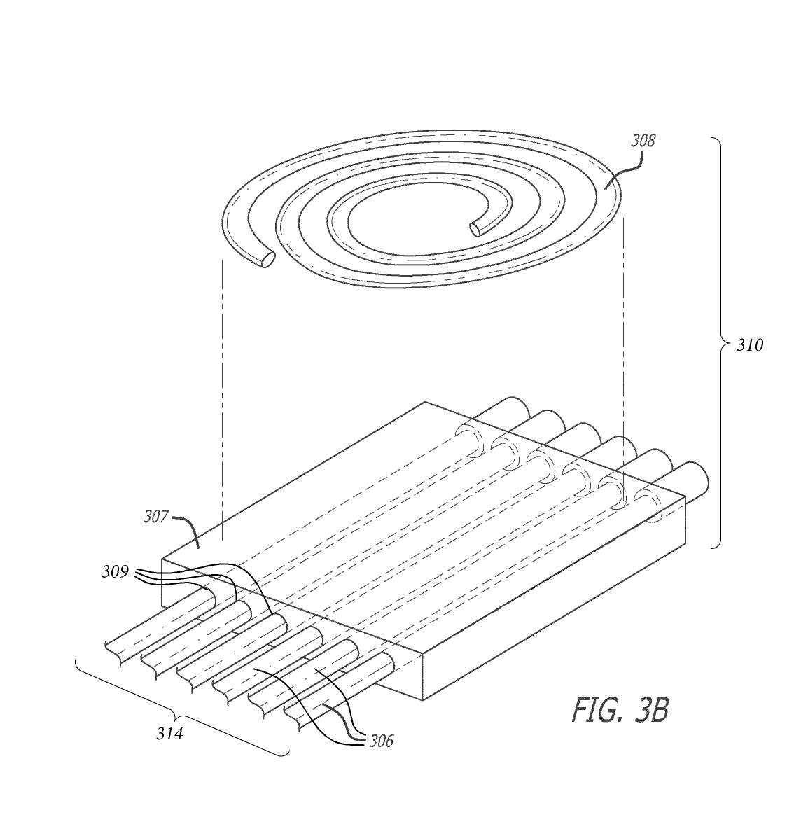

FIG. 3 is a diagram illustrating an embodiment of a furnace that includes a heating system as described herein. The furnace 300 includes a housing 325 that encloses the heat engine 310 and at least a portion of the thermal transfer device 314. The heat engine 310 includes a coil 308 and a thermal conductor 307. As mentioned previously, the thermal conductor 307 can include one or more substrates. In some embodiments, at least one substrate includes a ferrous metal positioned radially between turns of the coil and/or outside one or both terminal ends of the coil.

In the illustrated embodiment, the furnace 300 also includes a thermal transfer device 314 comprising a plurality of heat pipes 306 extending through at least a portion of the thermal conductor 307. As shown, the thermal conductor 307 encloses at least a portion of the heat pipes 306. Therefore, a portion of the heat pipes 306 are integrated into and/or circumferentially surrounded by a portion of the thermal conductor 307. In some cases, the thermal conductor 307 defines an extension of an interior wall of the heat pipes 306, such that the heat pipes 306 extend directly from the thermal conductor 307. Alternatively or in addition thereto, the thermal conductor 307 can define a contact surface either as an indentation on the substrate surface and/or as an aperture or through passage 309 within the thermal conductor 307 in which the heat pipes 306 contact either directly or indirectly. In some embodiments, the thermal conductor 307 can be molded to the heat pipes 306.

The heat pipes 306 can be fully contained within the housing 325 and couple directly to a heat exchanger 305 within the housing 325 to transfer the heat from the heat engine 310 to the air source, or may extend outside of the housing 325 and integrate or couple into another portion of the HVAC or heating system. If contained within the housing 325, the housing can also include a plenum or duct 303 to transport the heated air to the desired location and/or vent 304 to expel the air from the furnace. The duct 303 may take on any configuration to direct the heated air as desired.

As shown in the FIG. 3, in certain embodiments, the coil 308 is in a planar configuration, such that the coil 308 lies generally within a plane. Adjacent turns of the coil therefore lie radially outward or inward from subsequent turns to make a closed spiral. The thermal conductor 307 similarly has a planar configuration and lies adjacent to or in contact with the coil 308. The magnetic field generated by current in the coil 308 therefore penetrates at least a portion of the thermal conductor 307. Accordingly, a portion of the thermal conductor 307 located within the magnetic field can be a ferrous material such that the changing magnetic field induces heat in the ferrous material. The remaining portion of the thermal conductor 307 can be made of material having high thermal conductivity (ferrous or non-ferrous). As such, the heat generated by the coil 308 in the ferrous material of the thermal conductor 307 can be efficiently transferred to other portions of the thermal conductor 307. In some embodiments, the thermal conductor 307 can be made of a single substrate (e.g., a ferrous material) or can be made of one or more substrates (e.g., one or more layers of ferrous material and one or more layers of non-ferrous material).

In the illustrated embodiment of FIG. 3, the thermal conductor 307 has a plurality of aligned or generally aligned through passages 309 that define a contact wall. Similar to the passages 903 described above with reference to FIG. 9A, the passages 309 can extend through an entire length of the thermal conductor 307, or only a portion thereof and can have different widths, etc.

Although illustrated as being located on a single side of the coil 308, it will be understood that the coil 308 can be located between two thermal conductors. For example, the thermal conductor 307 illustrated in FIG. 3 can be a first thermal conductor and a second thermal conductor can be located on the other side of the coil 308. The two thermal conductors can be directly or indirectly in contact with the coil 308 and with each other. In such an embodiment, the coil 308 can be sandwiched between the two thermal conductors.

Similar, to the thermal conductor 308 shown in FIG. 3, the second thermal conductor can include one or more passages for one or more thermal transfer devices. In some cases, a single thermal conductor can be located on either side of the coil 308. For example, a thermal conductor can be molded to either side of the coil 308.

The plurality of heat pipes 306 can pass through the thermal conductor 307 and contact the contact wall defined by the through passages 309 in the thermal conductor 307. The heat pipes 306 can travel vertically to the heat exchanger 305 and transfer heat from the heat engine 310 to the remote location to warm an air stream. Some embodiments can also be used to heat a fluid stream, gas stream, medium, or object.

The furnace 300 can also include controls 320 to set a desired temperature or flow speed. For example, the unit can be powered by an outside or internal power source. The unit can include a power switch 321 to turn the unit on and off. The unit can also include temperature controls 323 for raising the output temperature or lowering the output temperature. In some embodiments, the furnace 300 can include a fan control speed 324 for setting the fan or blower speed and adjust the throughput of the system. In certain embodiments, the furnace 300 can include an output 322 such as a display to show a temperature, flow rate, current usage, etc. to a user to assess their input or output of the system. The controls 320 can be located remote from the furnace 300 or can be integrated into the housing 325.

In some embodiments, the heating system can be remotely mounted from a furnace and the thermostatic control placed in a remote register as a supplemental boost for room comfort temperature and control in a long reach ducting system where adequate heat from the HVAC air handler is insufficient for providing stable temperature or airflow, or is not able the thermostatically control temperatures in individual rooms. Therefore, the duct 303 can extend along, be positioned separately, or run in parallel to an existing HVAC duct to reach one or more specific spaces within a larger system. Control can be provided by individual thermostatic controls in each room or by a master control at the unit or common control location.

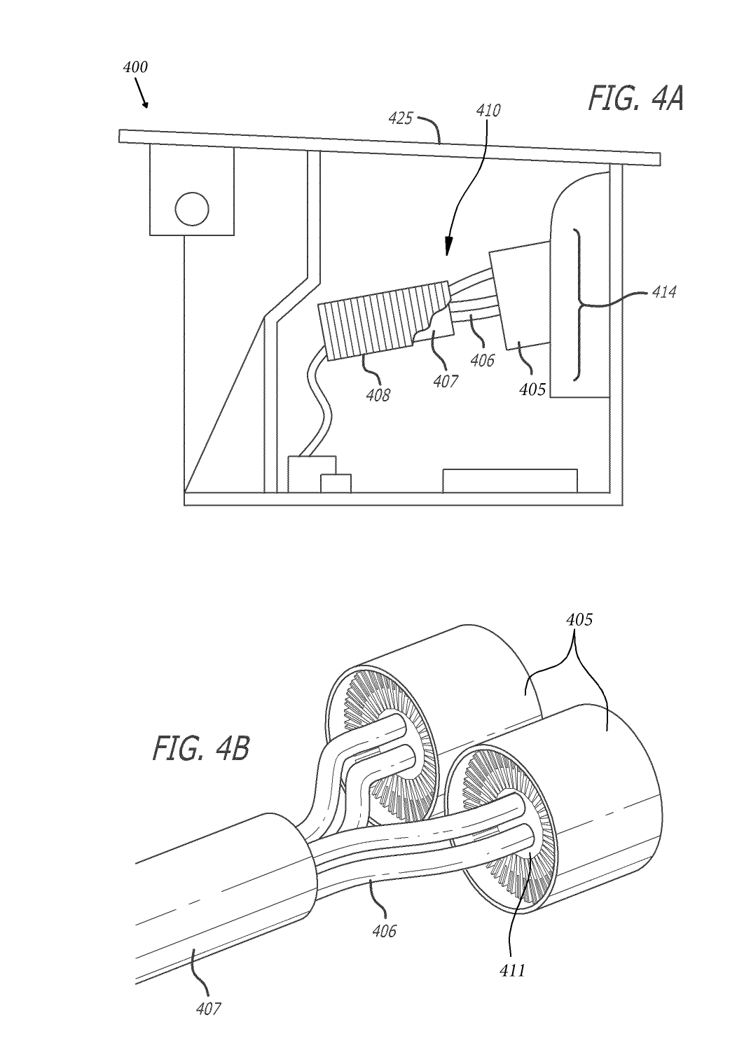

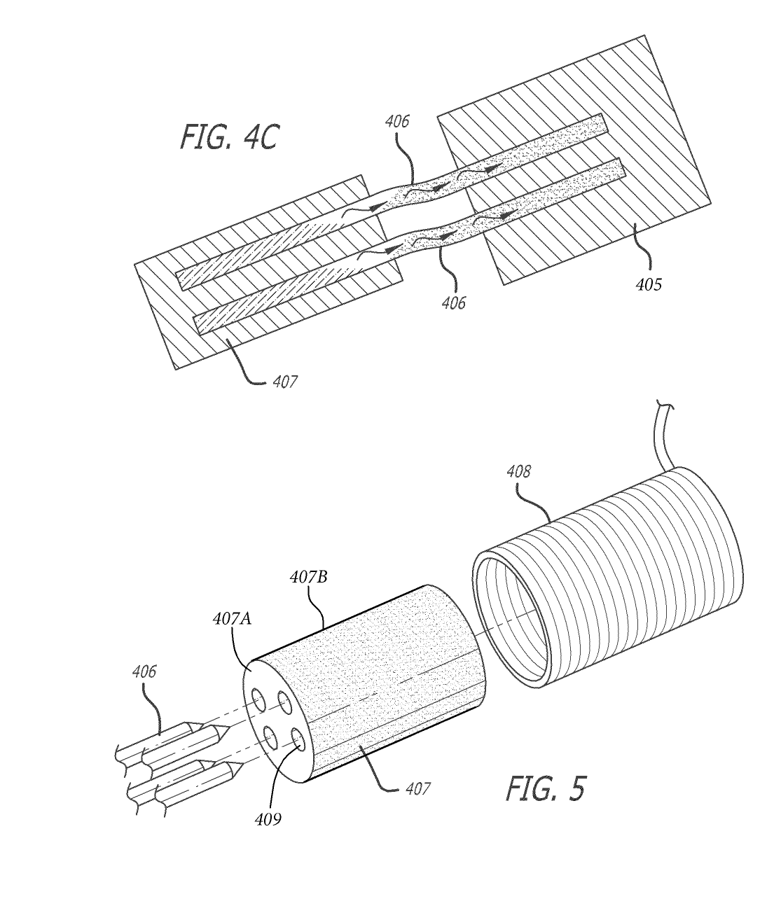

FIGS. 4A-4C are diagrams illustrating embodiments of a space heater that includes a heating system. In some embodiments, the space heater can be used to permit an occupant of a dwelling to turn down the thermostat on the heating system that serves the dwelling, whiling maintaining an elevated temperature locally, such as in one or more rooms or spaces.

As shown in FIG. 4A, the space heater 400 includes a portable housing 425. The portable housing 425 can include wheels or other mechanism to permit the unit to be easily moved from one location to another. The unit can also be lighter weight so that it can be picked up and carried by one person. The housing can enclose heat engine 410 that includes a thermal conductor 407 and coil 408, and that interfaces and interacts with thermal transfer device 414 including heat pipes 406.

In the embodiment illustrated in FIG. 5, the thermal conductor 407 includes a core 407A and a sleeve 407B. The core 407A can be made of metal or other thermal conductor and can be ferrous or non-ferrous. The sleeve 407B can be made of a ferrous material, such as a ferrous metal. Although the core 407A is illustrated as a circular cylindrical rod, it will be understood that other geometric cross sections can be used, including varying or constant cross dimensions, etc. Furthermore, although illustrated as having two substrates (core 407A, sleeve 407B), it will be understood that the thermal conductor can include fewer or more substrates. For example, in some embodiments, the thermal conductor 407 can include a single substrate, such as a ferrous metal. In certain embodiments, the core can include one or more cores 407A and/or one or more sleeves 407B.

In the illustrated embodiment, the thermal conductor 407 includes a plurality of apertures 409 on one end sized to accommodate a plurality of thermal transfer devices. In certain cases, the inner diameter of an aperture 409 can approximate the outer diameter of a thermal transfer device, such as a heat pipe 406, so heat transfer between the thermal conductor 407 and the thermal transfer device is facilitated. In certain embodiments, an intermediary contact, substance, or object can be introduced between a thermal transfer device and the thermal conductor 407 to further improve heat conduction between the thermal transfer device and the thermal conductor 407.

Although illustrated as having four apertures 409, it will be understood that the thermal conductor 407 can include fewer or more apertures 409. In some embodiments, the thermal conductor 407 can include a single aperture 409. The single aperture 409 can be sized to accommodate a single thermal transfer device or a plurality of thermal transfer devices. In certain embodiments, the thermal conductor 407 can include a plurality of apertures 409 and each aperture can be sized to accommodate a thermal transfer device or a plurality of thermal transfer device.

In the illustrated embodiment, a coil 408 is wrapped to define a longitudinal axis that aligns with the longitudinal axis of the thermal conductor 407. The coil 408 can include a plurality of turns to define a hollow cylinder configuration. The coil 408 can have a cross section that approximates the size and/or shape of the outer perimeter cross section of the thermal conductor 407 or may have a different cross section and/or size. In some embodiments, the coil 408 is sized such that it is in physical contact with the thermal conductor 407. In certain embodiments, the coil 408 is sized such that there is some space between the inner circumference of the coil 408 and the outer circumference of the thermal conductor 407.

Although illustrated as being located on the outside of the thermal conductor 307, it will be understood that the coil 408 can be located on the inside of the thermal conductor 407 and/or the coil 408 can be located between two thermal conductors. As a non-limiting example, a thermal conductor 407 can be sized such that an inner perimeter of the thermal conductor 407 is approximately equal to an outer perimeter of the coil 408. In such embodiments, the coil 408 can fit within the thermal conductor 407.

As yet another non-limiting example, the thermal conductor 407 illustrated in FIG. 4 can be a first thermal conductor and a second thermal conductor can be located on the outside side of the coil 408. The two thermal conductors can be directly or indirectly in contact with the coil 408 and with each other. In such an embodiment, the coil 408 can be sandwiched between the two thermal conductors. Similar, to the thermal conductor 408 shown in FIG. 4, the second thermal conductor can include one or more passages for one or more thermal transfer devices. In some cases, a single thermal conductor can be located on either side of the coil 408. For example, a thermal conductor can be molded to either side of the coil 408.

As mentioned above, as an alternating current passes through the coil 408, it can generate a changing magnetic field. The changing magnetic field can induce ferrous materials placed within the magnetic field to heat up. In some embodiments, a portion of the thermal conductor 407 can be made of a ferrous material, such as sleeve 407B. As such, when placed within the changing magnetic field generated by the coil 408, the ferrous portion of the thermal conductor 407 can heat up. The remaining portion of the thermal conductor 407 can be made of a material having a high thermal conductivity (ferrous or non-ferrous), such as a metal. Accordingly, the heat generated at the ferrous portion of the thermal conductor 407 can be transferred to the remaining portions of the thermal conductor 407.

As shown in the illustrated embodiment, heat pipes 406 are positioned within the thermal conductor 407, which is positioned within the coil 408. The heat pipes 406 can be configured to provide radiant heat or can be used with a heat exchanger and/or fan to provide convective and/or conductive heat. The space heater 400 can also include controls for setting a temperature, fan speed, or other input/output specifications.

With reference to FIG. 4C and as described above, a heatable solution can be located within at a proximal portion (portion coupled to the heat conductor 407) of the heat pipe 406. As the thermal conductor 407 heats up from the coils 408, the heat can be transferred to the proximal portion of the heat pipe 406. As the heat at the proximal portion of the heat pipe 406 increases, the heatable solution can turn into a vapor by absorbing the heat. The vapor can travel along the heat pipe 406 as shown in FIG. 4C to a distal portion of the heat pipe 406 (e.g., portion outside of the heat conductor 407 and/or coupled to a heat exchanger 405). As the heatable solution travels distally away from the proximal portion of the heat pipe 406, it can cool down and condense back into its non-vapor form (e.g., solid or liquid form) and release its latent heat. In some embodiments, the heatable solution can returns to the proximal portion through capillary action, centrifugal force, gravity, and combinations thereof to repeat the cycle. In this way, the heat pipe 406, or other heat transfer device, can transmit thermal energy from the proximal or heated portion of the heat transfer device to a distal or non-heated portion.

In certain embodiments, one or more heat pipes 406 can be made of a ferrous material. The ferrous material can be located on an outer or inner portion of the heat pipes 406. In such embodiments, a separate thermal conductor 407 can be omitted. The heat pipe 406 can be placed within the changing magnetic field generated by the coil 408 such that the heat pipes 406 are heated directly by the changing magnetic field.

The portions of the heat engine illustrated in FIG. 5 can be employed in the space heater 400, illustrated in FIG. 4. In the illustrated embodiment, four heat pipes 406 extend through at least a portion of the thermal conductor 407 and extend from the heat engine. The four heat pipes 406 can be coupled to a heat exchanger. In the illustrated embodiment of FIG. 4B, a plurality of heat exchangers 405 are used, such that the four heat pipes 406 are divided among two heat exchangers 405 (two heat pipes 406 per heat exchanger 405, however, the heat pipes 406 can be divided between the heat exchanger 405 in any combination). The heat pipes 406 extend through at least a portion of a core 411 of the heat exchanger 405 as discussed further with respect to FIG. 9A, above. A fan may be positioned within a duct or a vent to move an airflow through the system, across the heat exchanger 405 and out of the unit. The fan and heat engine may be independent controlled such that the unit may supply a selectable temperature, or temperature range, and air flow speed.

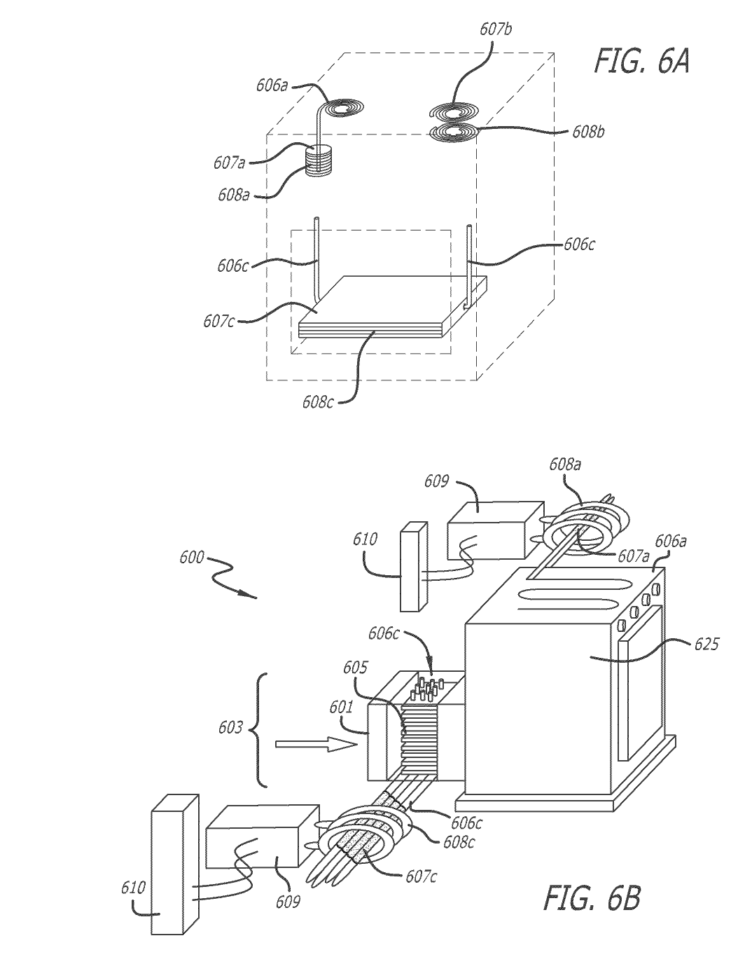

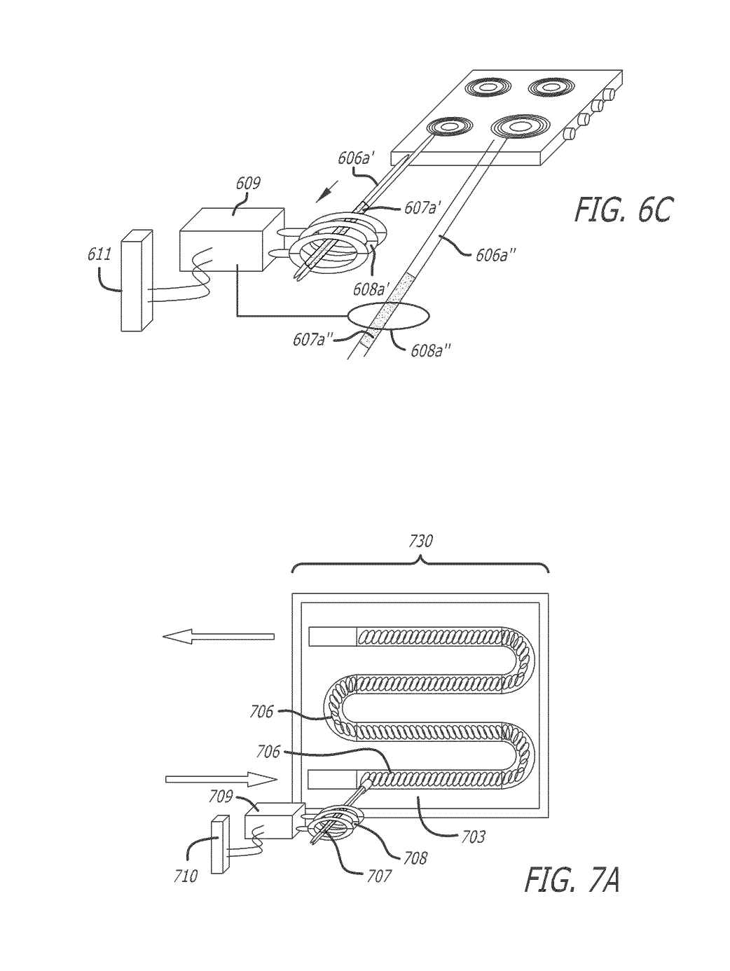

FIGS. 6A-6C are diagrams illustrating embodiments of various heating apparatus that include a heating system, including a stove and oven or other cook surfaces and spaces. As shown, the stove portion and/or the oven portion may take advantage of embodiments described herein.

With respect to a stove top embodiment, a coil 608a and coil 608b can be used to heat a thermal conductor 607a and thermal conductor 607b, respectively. The thermal conductor 607b can be directly on the stove top. In this configuration the thermal conductor/coil arrangement can be similar to that of FIG. 3 (with or without the heat pipes 306) in which the coil 608b and thermal conductor 607b are generally planar and positioned adjacent each other. The stove top may also take advantage of a thermal transfer device such as heat pipe 606a to provide flexibility in positioning the heat engine within the stove/over. The heat pipe 606a configuration can be used, for example, to reduce the stove size for use in mobile or camp stove applications in which the size/configuration is limited or otherwise constrained. Since the heat pipes are the primary source of heat energy in this embodiment, magnetic cookware as a thermal conductor for a typical induction stove top is unnecessary. Some embodiments described herein may be used with any conventional cookware.

With respect to the oven embodiment, a coil 608c can be used to heat a thermal conductor 607c positioned adjacent to or away from the interior oven space. Heat may be distributed around a periphery or throughout the interior oven space with thermal transfer device, such as heat pipes 606c. The exemplary embodiment here can use a combination of the heat engines as illustrated in FIGS. 3 and 4. For example, the coil 608c can wrap around a thermal conductor 607c. The thermal conductor 607c can be generally planar, while the coil is generally cylindrical (although short in longitudinal length) wrapped around the peripheral edge of the thermal conductor. Heat pipes 606c can extend through the thermal conductor and along the surface defining the interior cavity of the oven space. The heat pipes may be configured to create a desired heat distribution within the oven space.

FIG. 6B is a diagram illustrating an embodiment that includes two separate induction generators 609 and electrical controls 610 for controlling the oven space and cooktop surface separately. The oven space may be enclosed by a housing 625. Induction coils 608c can be used to heat thermal conductor 607c and transfer heat to heat pipes 606c. In the illustrated embodiment, the oven includes a duct assembly 603 for moving airflow by fan 601 through a heat exchanger 605 heated by heat pipes 606c.

The cooktop surface of the housing 625 is heated using coils 608a and thermal conductor 607a. The heating surface can include one or more heat pipes 606a above, at, integrated into, or under the cook surface. The heat pipes may be configured as conventional coiled heat spaces or may cover the entire cook surface. The heat pipes may be located such that the cook surface includes different heating zones or may include one or more additional generators and/or controls for adding heat to different heating areas to selectively control the heat provided to different areas of the cook surface. The illustrated heat surface can be used, for example, on an industrial stove top that heats a griddle type surface. Different combinations of coils and heat pipes can be used to create the desired heat distribution and selective control along the entire or different portions of the cooktop surface.

FIG. 6C is a diagram illustrating an embodiment of one or more induction generators 609 used to selectively control different plurality of coils 608a′ and 608a″ for heating different thermal conductors 607a′ and 607a″ to different plurality of heat pipes 606a′ and 606a″ to selectively and controllably heat individual cooking regions along cook top. For example, the coil(s) 608a″ can be independently controlled to generate heat within the heat conductor 607a″. The generated heat can be transferred to the heat pipe 606a″, which can deliver the heat to corresponding coils of the stove top. Similarly, the coil(s) 608a′ can be independently controlled to generate heat within the heat conductor 607a′. The generated heat can be transferred to the heat pipe 606a′, which can deliver the heat to corresponding coils of the stove top

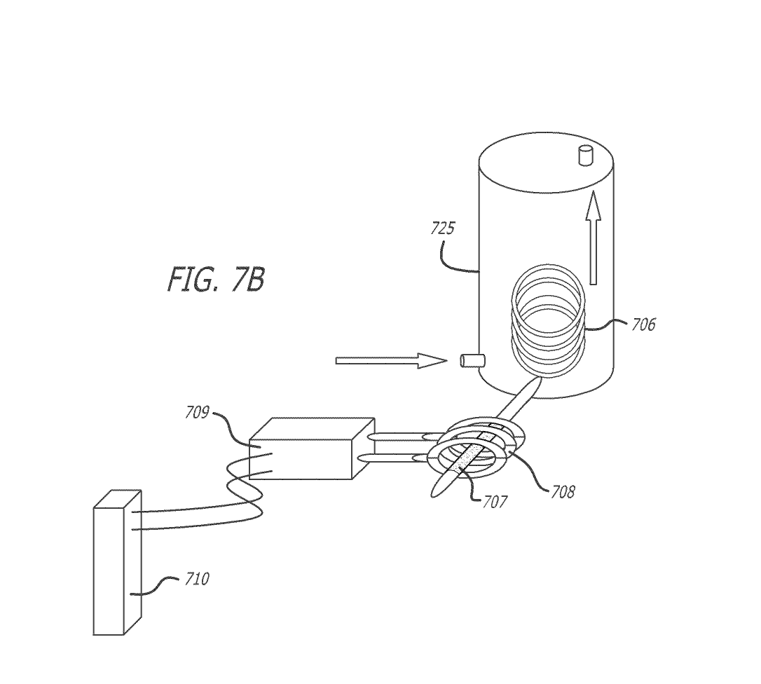

FIGS. 7A and 7B are diagrams illustrating embodiments of a water heater that includes a heating system. FIG. 7A illustrates an embodiment of an instant on hot water heater, while FIG. 7B illustrates an embodiment of a hot water unit. The configuration of FIGS. 7A and 7B work similar to the other embodiments described herein. However, instead of transferring heat from the heat engine to an air source as shown and described in one or more of the aforementioned embodiments, the heat generated by the heat engine of the embodiments described in FIGS. 7A and 7B, is transferred to the liquid, such a as water, held or passing through to create the desired hot liquid. In some embodiments, a coil and thermal conductor can be directly positioned around a portion of a pipe or liquid container. In certain embodiments, the heat pipes can be used to remotely locate the heat engine from the water tap and a heat exchanger can be used to heat the passing liquid.

As illustrated in FIG. 7A, embodiments of an instant on liquid heater can include a thermal conductor 707 inductively heated by coil 708, and controlled by induction generator 709 and electrical controls 710. The heat from the heat engine is transfer through heat pipes 706 in contact with water flowing through water pipes 703. As shown, the heat pipes 706 can be spirally positioned within the water pipes and directly contact the flowing water to the water source to increase heat transfer to the passing water. The heat pipes may also be positioned in other configurations such as longitudinally or parallel along the water pipe 703. The heat pipes 706 can also be positioned inside the pipe 703, outside the pipe 703, or a combination thereof. In some embodiments, the entire system can be mounted by mount 730, such as to or within a wall or cabinet surface.

As mentioned above, in some embodiments, the coil 708 and/or substrate 707 can be wrapped around at least a portion of the pipes 703. In such embodiments, the heat engine can heat a portion of the pipe 703.

As illustrated in FIG. 7B, embodiments of a hot water heater and tank may include an induction generator 709 controlled by electrical controls 710 for selectively controlling coils 708 to heat thermal conductor 707. The thermal conductor or heat pipes can be located in the water tank and directly or indirectly in contact with the water source or can be positioned on an outside of the water tank 725. The heat can be transferred from the thermal conductor 707 to the interior space of the tank 725 by heat pipes 706. The heat pipes can be positioned as coils, grid, parallel and longitudinal straight lines or other combinations to effectively transfer the heat to the liquid. The heat pipes 706 may be used with other heat exchangers (not shown) to improve heat transfer from the heat engine to the water.

FIG. 8 is a diagram illustrating an embodiment of an air dryer that includes a heating system. The embodiment of FIG. 8 can work similar to the embodiment described previously with reference to FIG. 6B, but with a different heat selection range. Given the selective controls of the system, applications in which the temperature is selectively controlled (i.e. baking temperatures and/or drying temperatures) are available. In some embodiments, greater temperature control can be provided than previous designs making these applications available to inductive heating. In the illustrated embodiment, the clothes dryer unit includes an electrical control 811 communicating with induction generator 809 for controlling induction coils 808 to selectively heat thermal conductor 807. The thermal conductor 807 transfers heat through heat pipes 806 to heat exchanger 805 to warm the air in the duct assembly 803 that is moved by fan 801 through duct 804 into the dryer drum 825a. The system can be fully or partially contained within the dryer box 825b. The exemplary air dryer may also be modified for other air drying applications, such as a hand air dryer. Because the heat engine can be located remote from the air source for drying, the drying body may be kept small, while the heat source is located remotely, such as in a wall or other place.

Other exemplary applications include, but are not limited to hot water heaters, coffee roasters and brewing equipment, HVAC equipment, swimming pool heaters, high volume heaters such as garage or torpedo area heaters. Applications can also include heating other substrate materials and configurations as are commercially available or developed.

All methods described herein can be performed in any suitable order unless otherwise indicated. Exemplary embodiments do not impose a limitation on the scope of the invention. In addition, exemplary embodiments described include system components, features, and functionality that are exemplary only. These system components, features, and functionality may be substituted with their equivalents and/or combined, integrated, removed, duplicated, added, or otherwise provided in any reasonable combination nor sub-combination from any one or more exemplary embodiments. Therefore, each exemplary embodiment is not intended to be mutually exclusive, but may be combined or recombined with other exemplary embodiments as would be apparent to a person of skill in the art. Therefore, any combination of the above described elements in all possible variations thereof is encompassed by the invention unless otherwise indicated herein or otherwise clearly contradicted by the context. The use of “and” and “or” is therefore interchangeable and any combination of the listed components, features, or functions may be used in any combination of elements.

Some embodiments described herein are in terms of an induction generator, induction coil, thermal conductor, and thermal transfer devices. The induction generator can be any source for creating a variable magnetic field at the thermal conductor through the coil. In some embodiments, the induction generator can be an alternating current source. The alternating current source can be controllable such as by electrical controls described herein to adjust power levels, frequency, or other attributes to adjust the magnetic field. The induction coil is not limited to any specific shape or design. Although “coil” is used herein it is not limited to the conventional wrapped wire understanding. The induction coil of the instant application can be any interface for generating the magnetic field. For example, it may be a helically or spirally wound wire that has terminal ends coupled to the induction generator for passing an alternating current and producing a fluctuating magnetic field. The induction coil may also simply be a wire or a plurality of wires or other electrically conductive medium in any configuration, such as a plurality of straight wires in parallel (physically and/or electrically).

Although embodiments of this invention have been fully described with reference to the accompanying drawings, it is to be noted that various changes and modifications will become apparent to those skilled in the art. Such changes and modifications are to be understood as being included within the scope of embodiments of this invention as defined by the appended claims.

What is claimed is:

1. A heating system, comprising:
an induction generator;
an induction coil operatively coupled to the induction generator and configured to create an adjustable magnetic field within a space;
a thermal conductor positioned within at least a portion of the space, the thermal conductor configured to generate heat when a changing magnetic field is applied thereto and including a passage extending at least partially there through; and
a heat pipe, enclosing a heatable solution, wherein at least a portion of the heat pipe is positioned in the passage such that an interior surface of the passage is in contact with an exterior surface of the heat pipe.

2. The heating system of claim 1, further comprising a heat exchanger thermally coupled to the heat pipe, wherein the heat pipe transfers the generated heat from the thermal conductor to the heat exchanger.

3. The heating system of claim 2, further comprising a fan configured to move an airflow across the heat exchanger.

4. The heating system of claim 3, further comprising a duct for directing the airflow from the heat exchanger.

5. The heating system of claim 4, further comprising an electrical controller configured to dynamically adjust a temperature generated by the heating system.

6. The heating system of claim 5, wherein the electrical controller is configured to control at least one of a power, a current, or a frequency, supplied by the induction generator to the induction coil.

7. A heating apparatus, comprising:
a heating assembly, the heating assembly comprising:
an induction generator,
an induction coil operatively coupled to the induction generator and configured to create an adjustable magnetic field within a space,
a thermal conductor positioned within at least a portion of the space, the thermal conductor configured to generate heat when a changing magnetic field is applied thereto and including a passage extending at least partially there through, and
a heat pipe each enclosing a heatable solution, wherein at least a portion of the heat pipe is positioned in the passage such that an interior surface of the passage is in contact with an exterior surface of the heat pipe; and
a housing enclosing at least a portion of the heat source.

8. The heating apparatus of claim 7, wherein the thermal conductor comprises a mass of non-ferrous material and a ferrous metal sleeve in physical contact with an exterior surface of the mass of non-ferrous material, wherein the passage extends at least partially through the mass of non-ferrous material.

9. The heating apparatus of claim 8, wherein the induction coil comprises a helically wound wire located around an exterior surface of the thermal conductor.

10. The heating apparatus of claim 7, wherein the heating assembly further comprises a heat exchanger thermally coupled to the heat pipe, wherein the heat pipe transfers the generated heat from the thermal conductor to the heat exchanger.

11. The heating apparatus of claim 10, wherein the heating assembly further comprises a fan configured to move an airflow across the heat exchanger.

12. The heating apparatus of claim 11, wherein the heating assembly is an oven and further comprises a heating space, wherein the airflow is directed to the heating space.

13. The heating apparatus of claim 12, further comprising a duct to direct the airflow from the heat exchanger to the heating space.

14. The heating apparatus of claim 10, wherein the heat exchanger further comprises fins extending radially outward from an exterior surface of a core.

15. The heating apparatus of claim 11, wherein the heating apparatus is clothes dryer and further comprises a dryer drum, wherein the airflow is directed to a cavity defined by the dryer drum.

16. The heating apparatus of claim 15, further comprising a duct to direct the airflow from the heat exchanger to the dryer drum.

17. The heating apparatus of claim 7, wherein the thermal conductor comprises a sleeve of ferrous material and a core of non-ferrous material, wherein the passage extends at least partially through the core of non-ferrous material.

18. The heating apparatus of claim 16, wherein the thermal conductor is cylindrical.

19. The heating apparatus of claim 7, wherein the heating apparatus is a space heater and the housing further comprises a vent.

20. The heating apparatus of claim 7, wherein the heating apparatus is a furnace and the housing further comprises a vent.
